(19) United States
(12) Patent Application Publication
(10) Pub. No.: US 2005/0047955 A1
(43) Pub. Date: Mar. 3, 2005

(54) Corrosion-resistant coating composition for steel, a coated steel product, and a steel coating process

(76) Inventor: William W. King, St. Mary's, CA (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/649,025

(22) Filed: Aug. 27, 2003

(51) Int. Cl. C22C 18/04; B32B 15/00

(52) U.S. Cl. 420/520; 428/659; 148/512

(57) ABSTRACT

A corrosion-resistant iron-aluminum intermetallic alloy layer coating for steel includes at least a 1 micron thick layer of iron-aluminum intermetallic. An iron-aluminum intermetallic layer is formed by displacing an iron-zinc layer by exposing the iron-zinc layer to a bath containing greater than 10 to 12 total weight percent aluminum, 0.5 to 7 total weight percent magnesium, and the remainder of the bath being zinc with inevitable impurities with the proviso that the bath is substantially devoid of mischmetal or a rare earth metal constituent thereof.

### FIELD OF THE INVENTION

The present invention generally relates to a corrosion-resistant coating composition, a coated steel, and a process of making such a coated steel, and in particular, to an aluminum-magnesium-zinc coating bath effective in creating an iron-aluminide surface layer on a steel substrate.

### BACKGROUND OF THE INVENTION

Mild steel with an unprotected surface contains iron atoms that are chemically reactive and capable of undergoing electrochemical reactions with a variety of chemical species including water vapor and acidic gasses to form iron oxides. Owing to the differences in iron oxide crystal structures relative to those found in mild steel, iron oxides have poor adhesion to steel with the dislodgement of iron oxide material exposing still more steel to electrochemical oxidation. Attempts to protect steel from rusting and ultimate structural failure create enormous economical burdens and occasional tragic accidents.

There have been countless prior art coatings and processes intended to protect steel from electrochemical oxidation. Unfortunately, all of these methods have invariably been effective for a period of time less than the useful life of the steel-containing article thereby resulting in the need for regular maintenance checks, reapplication of coatings, and often the replacement of the steel article. This represents a mere nuisance at the level of simple hardware fittings and fasteners. However, in complex piping or engineering structures, evaluation, recoating and replacing steel regularly exceeds the initial construction cost over the lifetime of the system.

Perhaps the simplest and oldest method of preventing electrochemical oxidation of steel by acidic atmospheric gases and water vapor is to coat the steel substrate with a coating impervious to atmospheric oxidants. Such barrier coatings are commonly described in the art as passive in that the barrier coating does not react to bind or otherwise react with an atmospheric oxidant. Illustrative of prior art barrier coatings are paints, lead-tin alloys, aluminum oxide, and hexafluoro-titanium phosphate. Passive barrier coatings are readily compromised by any coating imperfections that allow atmospheric oxidants to contact the underlying steel and thereby initiate the corrosion process.

Another method to slow the corrosive electrochemical oxidation of steel is to provide a sacrificial coating that is electrochemically more reactive than steel towards gaseous oxidants. Galvanic corrosion protection commonly uses metals such as zinc, aluminum and mixtures thereof to oxidize and thereby preventing underlying steel electrochemical oxidation. Galfan® (International Lead Zinc Research Organization) represents 5% by weight aluminum in a zinc alloy containing traces of mischmetal, where mischmetal is a blend of cerium and lanthanum. This alloy is representative of aluminum zinc coating alloys. Sacrificial coatings suffer from a degradation rate proportional to gaseous oxidant exposure. Since the thickness of a galvanic coating is finite, one must anticipate the sacrificial coating degradation rate prior to placing a steel article into service. Weld points and coating imperfections further lessen the operational lifetime of a steel substrate overlayered with a sacrificial coating.

A well-known and superior process for protecting steel is the combination of barrier coatings and galvanic coatings in combination as a multi-layer laminate coating. A multi-layer coating regardless of the complexity provides a passive barrier to atmospheric oxidant penetration with a barrier layer and reaction with an atmospheric oxidant by a sacrificial coating layer upon the barrier coating being compromised. While laminate coatings containing both barrier layers and active layers afford more effective corrosion resistance to steel, such coatings still cannot assure structural integrity to a steel article commensurate with many desired system lifetimes.

Additionally, a steel substrate can be made to be corrosion resistant through the formation of an intermetallic surface layer that is inherently corrosion resistant relative to steel. Aluminum-steel alloys such as iron aluminide are well-known as steel coatings, as detailed in U.S. Pat. No. 5,350,107. The reaction of a steel surface to form an intermetallic surface alloy of sufficient thickness to provide corrosion resistance remains a challenge. Furthermore, the ductility and strength of such intermetallic alloys relative to an underlying steel substrate often creates fabrication issues.

Representative of a multiplex combination steel coating system is REACOAT 15™ produced by Martinrea International, Mississauga, Ontario. The outer layer of the system is an aluminum-rich epoxy paint. The epoxy paint forms a passive barrier layer that slows the diffusion of gaseous oxidants therethrough. The diffusivity rate of polyatomic gaseous oxidants through the epoxy paint occurs at a rate proportional to the square root of film thickness. The aluminum flakes and/or particulate impregnated within the epoxy paint is initially an active component that reacts with gaseous oxidants to form aluminum oxides. Once formed, the aluminum oxide inclusions form a passive baffle increasing the diffusion path length of a gaseous oxidant within the epoxy paint layer. The effectiveness of aluminum flake or particulate impregnation depends on variables including aluminum loading volume, orientation of the flakes, and domain size. Excessive aluminum surface area degrades the physical integrity of the epoxy paint layer, while too little aluminum surface area within the epoxy paint layer disrupts interparticle electron flow between aluminum flakes or particles that are necessary to afford galvanic protection.

A hexafluoro-titanium phosphate crystal embedded in a silicon resin underlies the epoxy paint layer and serves as a passive barrier layer. Underlying the hexafluoro-titanium phosphate crystal layer is a Galfan® layer that is impervious to intragranular corrosion and reacts with gaseous reactants to form an aluminum oxide baffle that extends the diffusion path length to the underlying steel substrate. The effectiveness of a Galfan® layer depends upon the maintenance of a eutectic aluminum-zinc composition, as well as the film thickness. For film thicknesses of less than approximately 7 microns, steel corrosion failure times are proportional to Galfan® film thickness.

Chemical alloying of aluminum from a zinc-aluminum alloy layer and iron in the steel substrate forms an intermetallic iron aluminide of considerably less than one micron in thickness. While aluminum-steel alloys have exceptional corrosion resistance, the aluminum-steel alloy thinness and localized variations in formation associated with processing temperature and homogeneities associated with Galfan® application detracts from the corrosion resistance achieved by aluminum-steel alloy formation.

The ability to extend the serviceable lifetime of steel systems exposed to gaseous oxidants has met with only partial success. Thus, there exists a need for a more corrosion-resistant coating composition for steel, a resulting coated steel, and a process for the application of such a coating.

### SUMMARY OF THE INVENTION

A molten metallic bath for treating steel (second bath) includes greater than 10 to 12 total weight percent aluminum, 0.5 to 7 total weight percent magnesium, and the remainder of the bath being zinc with inevitable impurities. The molten bath is substantially devoid of mischmetal or a rare earth metal constituent thereof.

A corrosion-resistant steel is produced by contacting a clean mild steel surface with a first bath composed of a majority of zinc (no aluminum) by weight with inevitable impurities to form a 2-5 micron thick iron-zinc intermetallic layer. The steel with the iron-zinc intermetallic layer is then dipped into a second bath containing 10 to 12 total weight percent aluminum, 0.5 to 7 total weight percent magnesium, and the balance of the bath being zinc with inevitable impurities. The second bath serves to displace the zinc from the iron-zinc intermetallic layer and form an iron-aluminum intermetallic layer having a thickness of greater than 2-5 micron.

A corrosion-resistant steel includes a steel substrate with an iron-aluminum intermetallic alloyed layer in contact with the steel substrate.

### BRIEF DESCRIPTION OF THE DRAWINGS

FIG. 1 is a schematic illustrating a process for creating a multi-layer coated steel according to the present invention; and

FIGS. 2A-2D are cross-sectional electron micrographs showing the formation of an inventive intermetallic steel alloying with overlapping zinc (2A), iron (2B), and aluminum (2C) atomic mappings overlaid onto the Brightfield image of the same region (2D).

### DETAILED DESCRIPTION OF THE PREFERRED EMBODIMENTS

The present invention represents an innovation in the art of coating steel products in general and in particular plate and welded tube steels through the formation of an aluminum-iron alloy layer having a thickness of at least one micron.

As used herein, “mild steel” is defined to include those steels having a carbon content of less than 2.0% by volume. Representative mild steels operative herewith illustratively include M1006, M1008 and M010. According to the present invention, an aluminum-magnesium-zinc molten bath is brought into contact with a steel surface that has been cleaned of oxides so as to form an aluminum-iron intermetallic alloy integral with the steel surface, the alloy having a sufficient thickness of at least one micron to inhibit steel electrochemical oxidation by gaseous oxidants.

An inventive molten metallic bath includes from 10 to 50 weight percent aluminum, 0.5 to 7 weight percent magnesium, and the remainder of the solution being zinc. More preferably, the molten bath includes 10 to 12 weight percent aluminum and 1 to 5 weight percent magnesium. The bath is typically formed using 10% aluminum in zinc as ingots, which are dissolved in 50% aluminum in zinc or in zinc to make the 10% aluminum solution. More preferably, the molten bath includes 10 to 12 weight percent aluminum and 2 to 4 weight percent magnesium. The molten bath is substantially devoid of mischmetal, trace cerium and lanthanum.

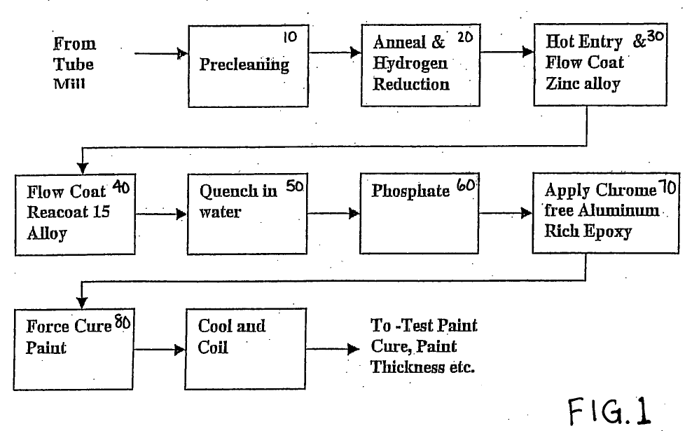

Referring now to FIG. 1, a mild steel article is physically and chemically cleaned by power abrasive brushing in an aqueous detergent solution heated to a temperature of 80° Celsius. Precleaning shown in FIG. 1 at 10 generally also includes rinsing the steel in deionized water with a sequential or preferably concomitant application of ultrasonic vibrations. Typically, ultrasonic vibrations are applied in the range of 3 to 50 megahertz. Thereafter, the steel is heated to a temperature sufficient to induce annealing 20. It is appreciated that the annealing temperature will be dependent on the specific steels being employed yet is generally about two-thirds of the steel melting temperature in degrees Kelvin. Typical annealing temperatures range from 660° C. to about 900° C. Annealing occurs under a reducing atmosphere so as to convert oxides present on the steel surface into zero valence metal and water vapor. Reducing atmospheres operative herein include hydrogen and an inert gas such as argon or helium and other conventional reducing atmospheres. Preferably, the reducing atmosphere is 5 volume percent hydrogen and nitrogen. Following anneal, the mild steel article is highly reactive. The hot steel is then contacted with a flow coat of molten zinc 30. Flow coating of the hot steel with molten zinc occurs under a reducing atmosphere such as that used during the anneal 20 or alternatively occurs under an inert atmosphere of di-nitrogen gas or a noble gas. Preferably, the molten zinc is substantially devoid of contaminants. Based on the nature of the mild steel, the zinc bath optionally contains from 0.01-0.9 total weight percent of a metal boride, metal carbide or silicon carbide where the additive particle size ranges from about 1 micron to about 250 microns. Metal borides operative herein illustratively include titanium boride, aluminum borides, and aluminum boro-carbide. Carbides operative herein illustratively include titanium, iron, tungsten, vanadium and silicon. It is appreciated that in addition to including metal boride or metal carbide particulate in the zinc bath, constituent atoms are added to the melt in stoichiometric amounts to achieve in situ formation of such particulate. The addition of metal carbides or borides is intended to modify the crystal growth characteristics of iron-zinc intermetallics. Upon contact between molten zinc optionally containing metal carbides and/or metal borides, iron atoms on the surface of the steel dissolve in the zinc melt so as to form an iron-zinc intermetallic layer that typically shows a gradual compositional transition through a plurality of iron-zinc intermetallics that vary in iron:zinc stoichiometry. Steel is then removed from the molten zinc and placed into a molten metallic bath including 10 to 12 weight percent aluminum, 0.5 to 7 weight percent magnesium and the remainder of the bath being zinc 40. Preferably, the zinc coated steel is immersed in the aluminum-magnesium-zinc bath under a reducing atmosphere as detailed with respect to the anneal step or optionally, the atmosphere is nitrogen or a noble gas. This alloy bath is maintained in a molten state at a temperature that ranges from about 400° C. to about 500° C. Maintaining the zinc-coated steel in contact with the alloy bath for a period of time ranging from about 1/3 seconds to 1/5 seconds, zinc and iron-zinc intermetallics on the steel surface are displaced by aluminum thereby forming iron-aluminum intermetallics. Preferably, the resulting iron-aluminum intermetallics contain from 18 to 49 weight percent aluminum with the remainder of the iron-aluminum intermetallic layer being iron. The thickness of the iron-aluminum intermetallic layer is between 1 micron and 5 microns. Preferably, the iron-aluminum intermetallic layer has a thickness of at least 2 microns.

Following sufficient immersion time of the steel in the alloy melt 40 to effect formation of an iron-aluminum intermetallic layer, the steel is removed from the melt and quenched in water 50. The quenched steel having an iron-aluminum intermetallic layer overlayered with a zinc-aluminum alloy layer is then immersed in an aqueous hexafluoro-titanium phosphate/silicon resin solution containing 20% by weight hexafluoro-titanium phosphate silicon resin solution. It is appreciated that other solvents capable of dissolving hexafluoro-titanium phosphate are also operative herein. While hexafluoro-titanium phosphate is operative herein as a phosphating agent, it is appreciated that other phosphates are also operative herein and illustratively include traces of aluminum and zinc phosphates. The phosphating agent etches the aluminum in the zinc overlayer above the iron-aluminum intermetallics increasing the steel surface aluminum alloy area up to forty-fold the pre-phosphate etched surface area. Typical phosphating agent etching times vary from 1/3 second to 1/5 second. It is appreciated that a more concentrated phosphating agent solution requires less contact time to exact a given etch. Steel surface area is readily measured by performing conventional surface area measurement through a blank isotherm experiment. Following phosphating agent etch, the steel is removed from the solution and allowed to dry thereby forming a layer of phosphating agent crystals and silicon resin.

An epoxy resin then overcoats the phosphated surface 70. Preferably, the epoxy resin contains between 20 and 30 total weight percent of a sacrificial reductant capable of reacting with a gaseous oxidant that permeates the epoxy overlayer. An epoxy resin operative herein illustratively includes epoxy/phenolic. The sacrificial reductant illustratively includes particles and/or flakes of aluminum, zinc and magnesium. More preferably, a sacrificial reductant particle or flake has a linear mean domain size of 0.5 to 3 microns. More preferably, the linear mean domain size is from 1.5 to 2.5 microns. An epoxy resin containing aluminum particulate as the sacrificial reductant and substantially devoid of chromium is a particularly preferred epoxy overcoating. After application of the epoxy resin, the steel substrate is exposed to thermal and atmospheric conditions conducive that promote epoxy cure and adhesion to the underlying phosphated surface. While it is appreciated that cure conditions for epoxy are dictated by the specific epoxy composition, satisfactory epoxy cures are generally obtained by heating the epoxy resin via induction to a temperature of between 275° C. and 350° C. in an air atmosphere for a time period of between 2 and 3 seconds.

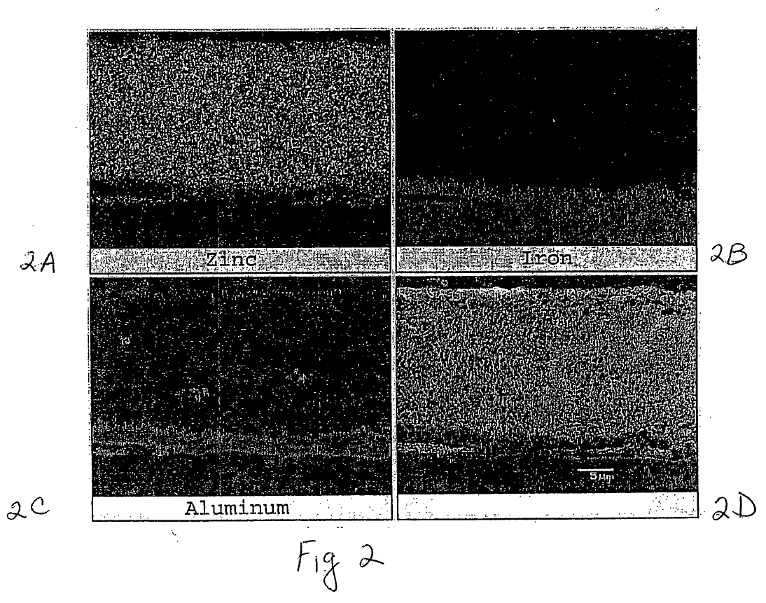

FIGS. 2A-2D are cross-sectional scanning electron micrographs of a mild steel substrate process according to the present invention process steps 10, 20, 30, 40 and 50 as detailed with respect to FIG. 1. An approximately 3 micron layer having a low electron reflectance is overlayered by an approximately 25 micron layer having high electron reflectance relative to the underlying steel is noted in the bright field scanning electron micrograph of FIG. 2D. Elemental mapping corresponding to the Brightfield image of FIG. 2D are shown for zinc (FIG. 2A), iron (FIG. 2B) and aluminum (FIG. 2C). FIGS. 2A-2C confirm that the low electron reflectance layer adjacent to the steel corresponds to iron-aluminum intermetallics specifically including iron aluminide. The high electron reflectance overlayer while containing some aluminum inclusions is predominantly zinc.

Patents and publications detailed in the specification are indicative of the level of skill in the prior art to which the invention pertains. These patents and publications are hereby incorporated by reference to the same extent as if each individual patent or publication was explicitly and specifically incorporated herein by reference.

One skilled in the art will appreciate various modifications can be made to the teachings of the present invention without departing from the intended spirit and scope thereof. It is intended that the present invention only be limited by the terms of the appended claims.

1. A molten metallic bath for treating steel consisting essentially of:
greater than 10 to 12 total weight percent aluminum;
0.5 to 7 total weight percent magnesium; and
the remainder of the bath being zinc with inevitable impurities.

2. The bath of claim 1 wherein said magnesium is present from 1 to 5 total weight percent.

3. The bath of claim 1 wherein said magnesium is present from 2 to 4 total weight percent.

4. A molten metallic bath comprising:
greater than 10 to 12 total weight percent aluminum;
0.5 to 7 total weight percent magnesium; and
78 to 89.5 total weight percent zinc with inevitable impurities.

5. The bath of claim 4 further comprising an additive selected from the group consisting of: a metal carbide, a metal boride, and a metal boro-carbide where the metal is titanium, vanadium, silicon, aluminum and zinc.

6. The bath of claim 5 wherein said additive is present from 0.01 to 0.9 total weight percent.

7. The bath of claim 4 wherein the bath is substantially devoid of a contaminant selected from the group consisting of: mischmetal or a rare earth metal constituent thereof.

8. A corrosion resistant steel comprising:
a steel substrate miscible with molten zinc; and
an adjacent iron-aluminum intermetallic alloy layer having a top surface and a bottom surface, said iron-aluminum intermetallic layer having a thickness of greater than 1 micron.

9. The steel of claim 8 wherein said iron-aluminum intermetallic comprises at least 18% aluminum by weight.

10. The steel of claim 9 wherein said iron-aluminum intermetallic layer has a thickness greater than 2 microns.

11. The steel of claim 9 wherein said iron-aluminum intermetallic layer has a thickness greater than 5 microns.

12. The steel of claim 9 wherein said iron-aluminum intermetallic layer has a thickness greater than 10 microns.

13. The steel of claim 9 wherein said iron-aluminum intermetallic layer has a thickness greater than 12 microns.

14. The steel of claim 9 further comprising a zinc layer having an upper surface in contact with the top surface of said iron-aluminum intermetallic layer.

15. The steel of claim 14 wherein said zinc layer has a thickness of between 5 and 50 microns.

16. The steel of claim 15 wherein said zinc layer has a thickness of between 10 and 35 microns.

17. The steel of claim 9 further comprising a phosphating agent crystalline layer in contact with the upper surface of said zinc layer.

18. The steel of claim 17 wherein said phosphating agent crystalline comprises hexafluoro-titanium phosphate.

19. The steel of claim 9 further comprising an aluminum particulate filled cured epoxy overlayer adhering to said phosphating agent crystalline layer.

20. The steel of claim 9 wherein said iron-aluminum intermetallic layer is from 19 to 25 total weight percent aluminum.

21. The steel of claim 9 with the proviso that said iron-aluminum intermetallic layer is substantially devoid of rare earth metals.

22. The steel of claim 9 wherein said steel substrate is formed as a tube.

23. A process for forming a corrosion resistant steel comprising the steps of:
contacting a clean mild steel surface with a first bath comprising a majority of zinc component by weight with inevitable impurities so as to form an iron-zinc intermetallic layer; and
dipping said iron-zinc intermetallic layer into a second bath comprising from greater than 10 to 12 total weight percent aluminum, 0.5 to 7 total weight percent magnesium and a balance of said bath being zinc with inevitable impurities so as to displace at least in part said iron-zinc intermetallic layer and form an iron-aluminum intermetallic layer having a thickness of greater than 1 micron and an overlayer of zinc-aluminum alloy.

24. The process of claim 23 wherein the step of coating the iron-zinc intermetallic layer with said second bath occurs under an inert or reducing atmosphere.

25. The process of claim 23 wherein the first bath is substantially devoid of mischmetal or a rare earth metal constituent thereof.

26. The process of claim 23 wherein said second bath is substantially devoid of mischmetal or a rare earth metal constituent thereof.

27. The process of claim 24 wherein said iron-aluminum intermetallic layer contains from 19 to 25 weight percent aluminum.

28. A steel formed by the process of claim 23.

29. The use of an iron-aluminum intermetallic layer having a thickness of at least 1 micron and overlayered with zinc to protect an underlying steel substrate.

30. The use of an iron-aluminum intermetallic layer of claim 29 wherein at least 98% by volume of said iron-aluminum intermetallic layer is iron aluminide.
